(19) United States
(12) Patent Application Publication
(10) Pub. No.: US 2015/0348416 A1
(43) Pub. Date: Dec. 3, 2015

(54) OBSTACLE DETECTION DEVICE AND ELECTRIC-POWERED VEHICLE PROVIDED THEREWITH

(71) Applicant: SHARP KABUSHIKI KAISHA, Osaka-shi (JP)

(72) Inventors: Hideaki FUJITA, Osaka-shi (JP); Kazuhisa OKADA, Osaka-shi (JP); Takehide MATSUMOTO, Osaka-shi (JP); Yuuki MATSUOKA, Osaka-shi (JP)

(21) Appl. No.: 14/759,284

(22) PCT Filed: Jan. 15, 2014
(86) PCT No.: PCT/JP2014/050583

§ 371 Date: Jul. 6, 2015

(30) Foreign Application Priority Data
Mar. 26, 2013 (JP) 2013-064962

(51) Int. Cl. G08G 1/16; B60R 1/00

(52) U.S. Cl. CPC G08G 1/16; B60R 1/00; B60R 2300/105; B60R 2300/107; B60R 2300/301; B60R 2300/8093

(57) ABSTRACT

An obstacle detection device (4A) which has cameras (12a, 12b) for detecting an obstacle, and notifies a user when the obstacle is detected by the cameras (12a, 12b). A reliability calculation unit (14) for calculating reliability of detection of the obstacle by the cameras (12a, 12b), a determination unit (15) for comparing the reliability which is calculated with a threshold and determining that the reliability has decreased when the reliability is less than or equal to the threshold, and a notification unit (20) for drawing attention of the user when the determination unit (15) determines that the reliability has decreased are provided therein.

### TECHNICAL FIELD

The present invention relates to an obstacle detection device which is used being mounted on an electric-powered vehicle such as an electric-powered wheelchair, and the electric-powered vehicle provided therewith.

### BACKGROUND ART

In recent years, three-wheel or four-wheel one-sheet electric-powered vehicles which are made for elderly people have been in widespread use and known as electric-powered wheelchairs and mobility scooters.

The electric-powered vehicle has a small vehicle body compared to a car and are used by elderly people in many cases. Therefore, an obstacle such as a step is a risky place with a possibility of falling down for the electric-powered vehicle and it is desired to detect the obstacle in advance to notify a driver.

Thus, a technology by which an obstacle which is on a road is detected by a radar, ultrasonic waves, a camera image or the like has been proposed conventionally. Specifically, for example, for a step detection device and an electric-powered vehicle provided therewith described in PTL 1, an obstacle detection technology by using a camera image is disclosed, and for an obstacle detection device described in PTL 2, an obstacle detection technology by using ultrasonic waves is disclosed.

### CITATION LIST

### Patent Literatures

PTL 1: Japanese Unexamined Patent Application Publication No. 2011-177334 (Publication date: Sep. 15, 2011)

PTL 2: Japanese Unexamined Patent Application Publication No. 2011-133247 (Publication date: Jul. 7, 2011)

PTL 3: Japanese Unexamined Patent Application Publication No. 2005-106649 (Publication date: Apr. 21, 2005)

### SUMMARY OF INVENTION

### Technical Problem

However, the aforementioned conventional obstacle detection device and electric-powered vehicle provided therewith have following problems.

First, the electric-powered vehicles such as electric-powered wheelchairs and mobility scooters are treated as pedestrians, and therefore also pass on a place where no car travels, such as a passage in a hospital or a shop in addition to an outside sidewalk in some cases, so that it is necessary to assume usage under a wide variety of situations.

Against this, the step detection device and the electric-powered vehicle provided therewith disclosed in PTL 1 propose a technology by which an obstacle is detected from camera images which are captured at different times. In a method using a camera, however, there may be a case where erroneous judgment is caused under a situation where a desired image is not able to be obtained because of an irradiation state of illumination light, reflection of a target object or the like. For example, in the case of weather like rainy weather or fog, an illumination condition like a dark place or backlight, or having reflection of a floor surface or reflection of a surrounding sight, probability of causing erroneous judgment increases.

Moreover, the obstacle detection device disclosed in PTL 2 proposes a technology by which ultrasonic waves are irradiated to detect an obstacle from a time delay of reflective waves from a target object. However, similarly, probability of causing erroneous judgment increases in the case of weather like rainy weather or fog, or for an obstacle of a shape from which reflective waves are difficult to be returned because of a curved surface or an inclined surface, for descending stairs or a step of a concave shape like a ditch from which reflection waves are not returned, or an obstacle which absorbs ultrasonic waves.

Accordingly, it is preferable in the obstacle detection device that reliability of a determination result is able to be grasped in consideration of risk factors by which probability of causing erroneous judgment increases.

On the other hand, in a car navigation field which is a field different from that of the invention of the present application, a technology regarding visibility of a navigation screen that allows driving without seeing a monitor screen and without moving a sight line by projecting a scenery of the navigation screen on a windshield or the like is disclosed in PTL 3.

As described that “Target objects include ones which are able to be identified visually, such as gas stations, convenience stores, restaurants, hotels, hot spring resorts, facilities including public or other buildings, or landforms including mountains, rivers or lakes.”, this PTL 3 targets a scenery and is not regarding risk factors. Moreover, as described that “Specific precision means accuracy that instruction display (such as an arrow) which is displayed being superposed with an actual scenery indicates a target object, and high (excellent) specific precision means that the instruction display (such as an arrow) indicates the target object in the actual scenery accurately,”, precision with respect to a positional relation with the scenery which is actually seen by a driver is shown. Accordingly, it is not judgment precision with respect to a risk degree.

Further, though it is described that “Precision detection means detects specific precision based on oscillation of a vehicle, behavior of the vehicle, posture change of an occupant of the vehicle, specific precision of a current position of the vehicle, an apparent interval of a plurality of target objects to be displayed, an apparent size of a target object to be displayed, or a distance to a target object to be displayed.”, this precision detection means is neither regarding detection of risk factors.

In this manner, it can be also said that the technology of PTL 3 is similar in terms of notifying the occupant of specific precision, but a technical field and an object thereof are different from those of the invention of this application as well as judgment precision of a risk degree and the precision detection means are also different from those of the invention of this application.

The present invention has been made in view of the aforementioned conventional problem, and an object thereof is to provide an obstacle detection device capable of being used more safely and at ease by reducing erroneous judgment, and an electric-powered vehicle provided therewith.

### Solution to Problem

An obstacle detection device in one aspect of the present invention is an obstacle detection device that has an obstacle detection sensor for detecting an obstacle, and notifies a user when the obstacle is detected by the obstacle detection sensor, the obstacle detection device including: a reliability calculation unit for calculating reliability of detection of the obstacle by the obstacle detection sensor, a first determination unit for comparing the reliability which is calculated with a threshold and determining that the reliability has decreased when the reliability is less than or equal to the threshold, and a first attention drawing unit for drawing attention of the user when the first determination unit determines that the reliability has decreased.

An electric-powered vehicle in one aspect of the present invention comprises the obstacle detection device described above.

### Advantageous Effects of Invention

According to one aspect of the present invention, an effect is exerted that an obstacle detection device capable of being used more safely and at ease by reducing erroneous judgment and an electric-powered vehicle provided therewith are provided.

### BRIEF DESCRIPTION OF DRAWINGS

FIG. 1 is a block diagram showing a configuration of an obstacle detection device in an embodiment 1 of the present invention.

FIGS. 2(a) and 2(b) are perspective views showing a configuration of an electric-powered vehicle provided with the aforementioned obstacle detection device.

FIG. 3 is a perspective view showing a configuration of an obstacle detection sensor unit in the aforementioned obstacle detection device.

FIG. 4(a) is a view showing a first image captured by a left-side camera, 4(b) is a view showing a second image captured by a right-side camera, and 4(c) is a view in which the first image and the second image are superposed and only each border line between a sidewalk and a road surface is extracted.

FIG. 5(a) is an explanatory view showing a method for calculating a distance, which shows the first image in a coordinate space, and 5(b) is a side view showing a focal plane of the cameras and position information of the cameras.

FIG. 6(a) shows a method for calculating disparity, which is a side view showing the camera and 6(b) is a plan view showing the right and left cameras.

FIG. 7(a) is a view showing the first image on a left side in which an origin P is seen at a coordinate of an origin (0, 0), and 7(b) is a view showing the second image on a right side in which the origin P is seen at a point of (−v1, 0).

FIG. 8(a) is a side view showing a case where disparity v2 of an object is positive (larger than disparity v1 of a road surface), and 8(b) is a side view showing a case where the disparity v2 of the object is negative (smaller than the disparity v1 of the road surface).

FIG. 9(a) is a front view showing a configuration when an LED display unit is lit in a notification unit of the aforementioned obstacle detection device, and 9(b) is a front view showing a configuration when only an upper-right LED display unit indicating a risky position and a risk level is lit in the notification unit of the aforementioned obstacle detection device.

FIG. 10 is a flowchart showing obstacle detection operation of the aforementioned obstacle detection device.

FIG. 11 is a perspective view showing a configuration of an obstacle detection sensor unit of an obstacle detection device in an embodiment 2 of the present invention.

FIG. 12 is a flowchart showing obstacle detection operation of the aforementioned obstacle detection device.

FIG. 13 is a perspective view showing a configuration of an obstacle detection sensor unit of an obstacle detection device in an embodiment 3 of the present invention.

FIG. 14 is a flowchart showing obstacle detection operation of the aforementioned obstacle detection device.

### DESCRIPTION OF EMBODIMENTS

### Embodiment 1

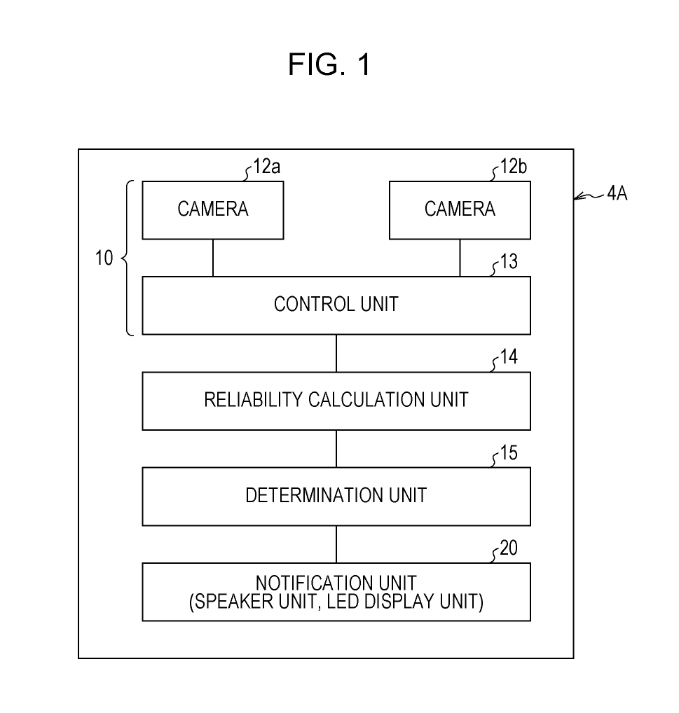

Description will be given as follows for one embodiment of the present invention based on FIG. 1 to FIG. 10.

An electric-powered vehicle provided with an obstacle detection device of the present embodiment is a vehicle which is movable by electric power, and represents, for example, a one-sheet small vehicle such as an electric-powered wheelchair or a mobility scooter, an electric car, or the like.

Moreover, an obstacle is an object which obstructs passing of the electric-powered vehicle, and represents, for example, a ditch, a step in a lower direction than a ground surface such as descending stairs, a pedestrian, a wall, a step in an upper direction than a ground surface such as ascending stairs, a slope having a large inclination angle, for example, 10° or more, or the like.

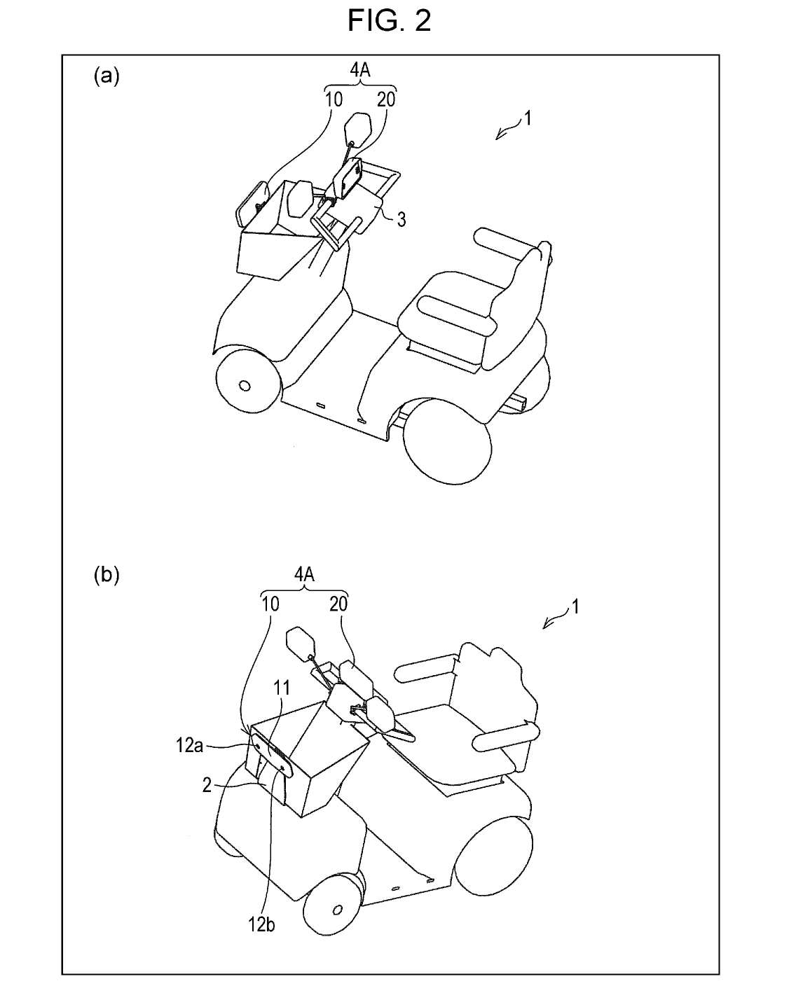

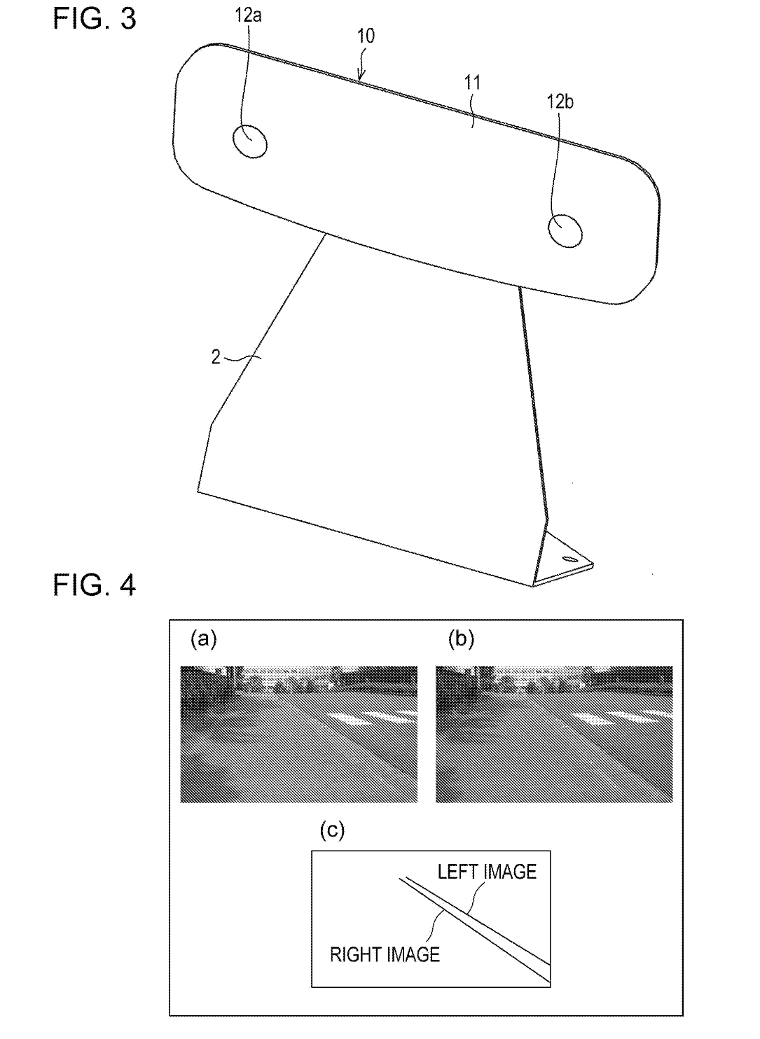

Description will be given for a configuration of the electric-powered vehicle provided with the obstacle detection device of the present embodiment based on FIGS. 2(a) and (b) and FIG. 3. FIGS. 2(a) and (b) are perspective views showing the configuration of the electric-powered vehicle provided with the obstacle detection device of the present embodiment. FIG. 3 is a perspective view showing a configuration of an obstacle detection sensor unit in the aforementioned obstacle detection device.

An electric-powered vehicle 1 provided with an obstacle detection device 4A of the present embodiment includes an obstacle detection sensor unit 10 which is fixed to a sensor fixation unit 2 provided in a forefront part in an advancing direction in the electric-powered vehicle 1 as shown in FIGS. 2(a) and (b). A notification unit 20 as an attention drawing unit is provided in a handle operation unit 3 of the aforementioned electric-powered vehicle 1. The aforementioned obstacle detection sensor unit 10 and notification unit 20 function as components of the obstacle detection device 4A of the present embodiment. Note that, the notification unit 20 is attached at a position being easily viewed by a driver (user) in the present embodiment, but, without being necessarily limited thereto, in the case of only sound and voice, may be provided at another position of the electric-powered vehicle 1.

The aforementioned obstacle detection sensor unit 10 detects an obstacle in the advancing direction, and has two cameras 12a and 12b as an obstacle detection sensor and a stereo camera in a sensor cover 11 as shown also in FIG. 3. An interval between these cameras 12a and 12b is, for example, 15 to 25 cm. Moreover, in the aforementioned sensor cover 11, a not-shown control unit 13 described below for calculating a distance to the obstacle or a height of the obstacle from signals of the cameras 12a and 12b, a not-shown reliability calculation unit 14 described below for calculating reliability of detection of the obstacle by the aforementioned cameras 12a and 12b, and a not-shown determination unit 15 described below for comparing the aforementioned reliability which is calculated with a threshold and determining that the reliability has decreased when the reliability is less than or equal to the threshold are arranged.

That is, in the obstacle detection sensor unit 10 of the present embodiment, with a stereo camera method using the two cameras 12a and 12b, a distance to the obstacle and a height of the obstacle are measured from disparity of both of the cameras 12a and 12b.

Here, description will be given for a method for calculating a distance to and a height of an obstacle from disparity of the stereo camera based on FIGS. 4 (a), (b) and (c). FIG. 4 (a) is a view showing a first image captured by the left-side camera, FIG. 4(b) is a view showing a second image captured by the right-side camera, and FIG. 4(c) is a view in which the first image and the second image are superposed and only each border line between a sidewalk and a road surface is extracted.

First, when a front side is shot by each of the cameras 12a and 12b, the first image captured by the left-side camera 12b shown in FIG. 4(a) and the second image captured by the right-side camera 12a shown in FIG. 4(b) are acquired. Then, it is grasped from both of these images that the left image and the right image are captured with the border line at shifted positions, as shown in FIG. 4(c). This laterally shifted amount is disparity, and the disparity decreases at a fixed rate from a front side to a depth side on a flat road surface.

In the present embodiment, by comparing such disparity v1 on the flat road surface with actual disparity v2 obtained by capturing an image of a detection region of a step, a height from the road surface of the detection region is detected.

Specifically, the disparity v1 when it is assumed that, with respect to the detection region with an arbitrary coordinate (X, Y) of the first image as a center, from a Y-coordinate thereof, position information of the camera 12b and the like, the detection region is on the road surface is obtained. Then, a comparison region with a coordinate (X−v1, Y) obtained by being shifted by the disparity v1 in the second image as a center is defined, so that the height from the road surface in the detection region is able to be obtained from the disparity v2 of the image of the detection region and the image of the comparison region.

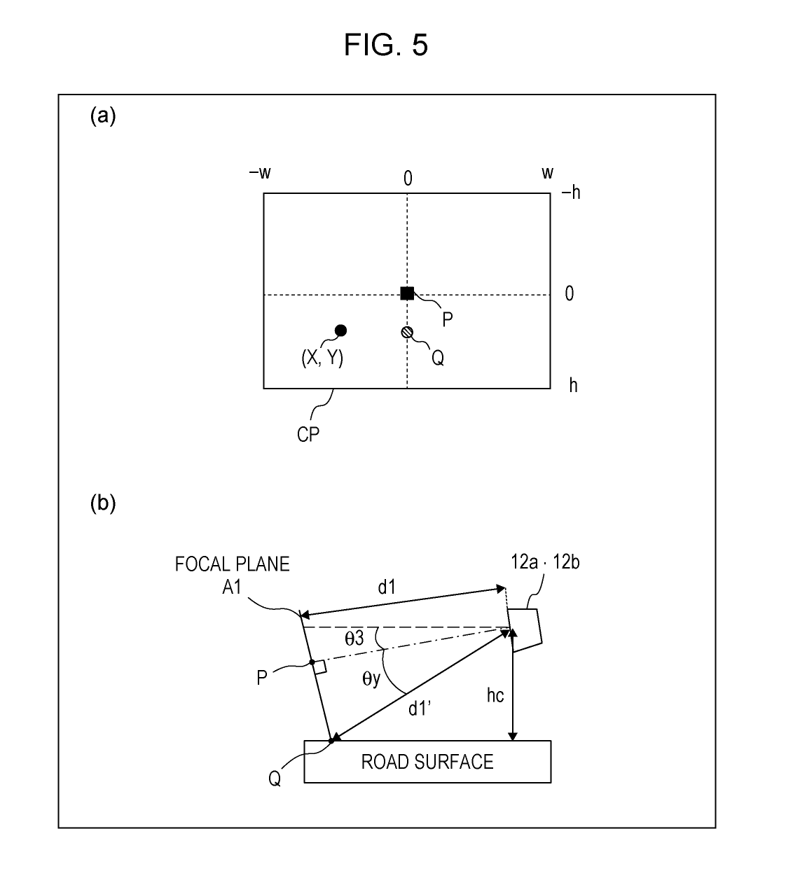

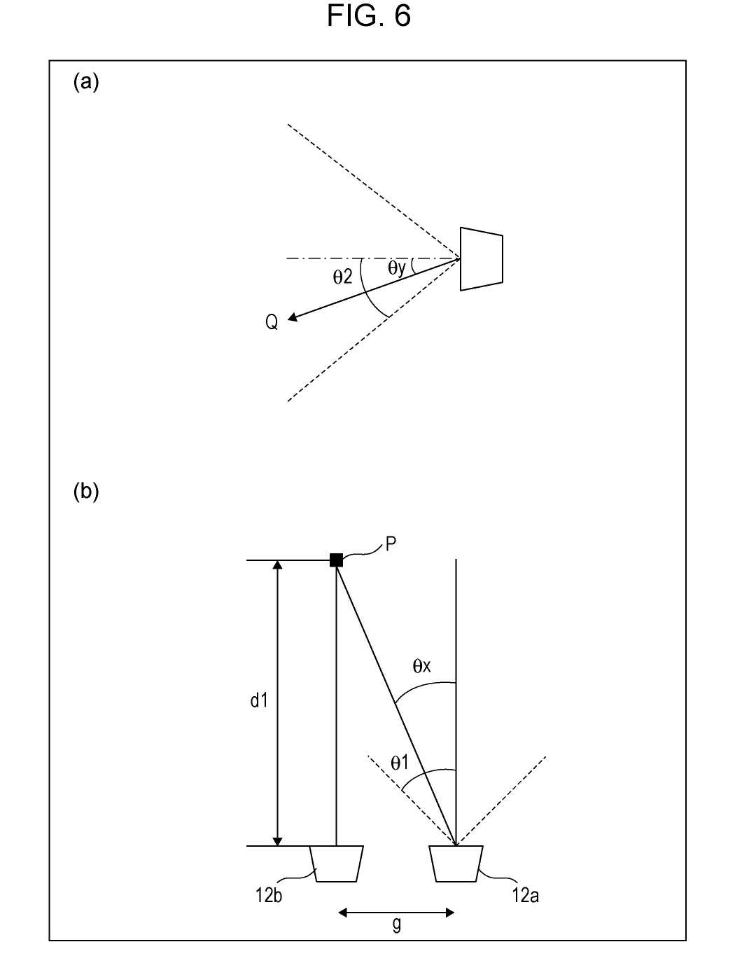

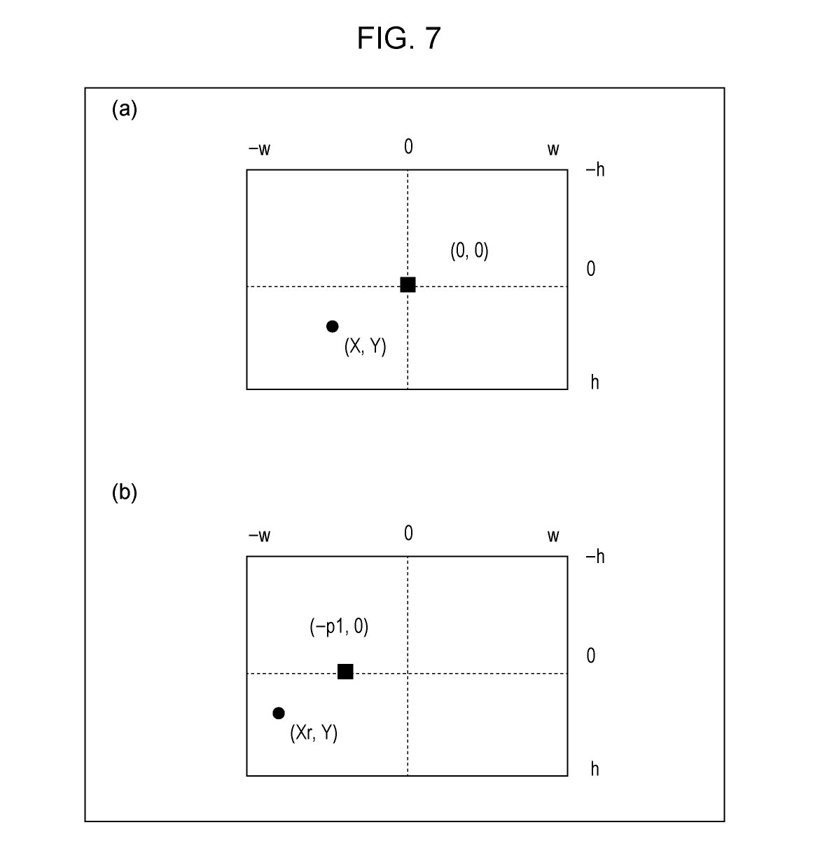

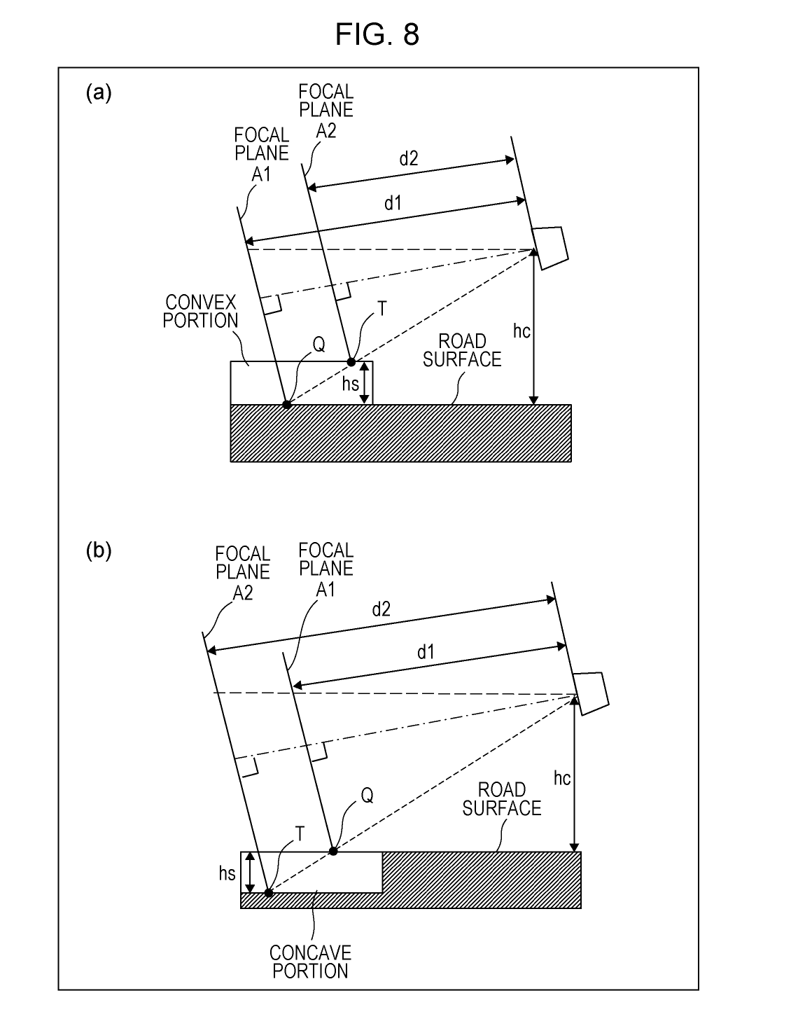

Description will be given for a specific method for calculating a distance to and a height of an obstacle from disparity of the stereo camera based on FIGS. 5(a) and (b) to FIGS. 8(a) and (b). FIG. 5(a) is an explanatory view showing a method for calculating a distance, which shows the first image in a coordinate space, and FIG. 5(b) is a side view showing a focal plane of the cameras and position information of the cameras. FIG. 6(a) shows a method for calculating disparity, which is a side view showing the camera and FIG. 6(b) is a plan view showing the right and left cameras. FIG. 7(a) is a view showing the first image on a left side in which an origin P is seen at a coordinate of an origin (0, 0), and FIG. 7(b) is a view showing the second image on a right side in which the origin P is seen at a point of (−v1, 0). FIG. 8(a) is a side view showing a case where disparity v2 of an object is positive (larger than disparity v1 of a road surface), and FIG. 8(b) is a side view showing a case where the disparity v2 of the object is negative (smaller than the disparity v1 of the road surface).

First, as shown in FIGS. 5(a) and (b), the disparity v1 with respect to the second image when it is assumed that, with respect to a detection region with an arbitrary coordinate (X, Y) of the first image as a center, from a value of the Y-coordinate thereof and position information of the camera 12b, the detection region is on the road surface is obtained.

In order to obtain the disparity v1, first, as shown in FIG. 5(b), a distance d1 from the cameras 12a and 12b to a focal plane A1 of an image needs to be calculated. Thus, as shown in FIG. 5(a), the first image is converted to a coordinate space CP in which a height is ±w pixels and a width is ±h pixels with a center of the coordinate (0, 0) as the origin P, and a coordinate point (X, Y) of a detection region of a step is displayed in the coordinate space CP.

Subsequently, an arbitrary coordinate point (X, Y) of the detection region in which the step is detected is selected in the coordinate space CP. The coordinate space CP corresponds to the focal plane A1 which is a plane vertical to optical axes of the cameras 12a and 12b shown in FIG. 5(b). When lenses of the cameras 12a and 12b have no distortion, ones which exist on the focal plane A1 all have same disparity, so that the coordinate point (X, Y) and the origin P which exist in the coordinate space CP also have same disparity.

Next, the distance d1 from the camera 12b to the origin P of the focal plane A1 when it is assumed that the coordinate point (X, Y) exists on the road surface is obtained. Here, calculation of the distance d1 with the coordinate point (X, Y) as a base point brings complication. Thus, by utilizing that all the coordinate points existing on the focal plane A1 have same disparity, the distance d1 to the origin P of the focal plane A1 is calculated with a coordinate point Q (0, Y) which is on the same focal plane A1 with the coordinate point (X, Y) as the base point.

Next, as shown in FIG. 6(a), as to a downward angle θy when the coordinate point Q is seen from the camera 12b, when a half of a vertical view angle of the camera 12b is θ2, since a height of the coordinate point Q shown in FIG. 5(a) is Y, θy is able to be obtained with a following formula 1.

θy=arctan(tan θ2×Y/h) (formula 1).

Moreover, as shown in FIG. 5(b), when a height at which the cameras 12a and 12b are attached is set as hc and the cameras 12a and 12b are attached downwardly at a depression angle θ3, a distance d1′ from the camera 12b to the coordinate point Q is able to be obtained with:

d1′=hc/sin(θ3+θy) (formula 2).

Accordingly, the distance d1 from the camera 12b to the origin P of the focal plane A1 is able to be obtained with:

d1=d1′×cos(δy) (formula 3).

Next, disparity v1 of the first image and the second image when it is set that the road surface is on the focal plane A1 is obtained. In the case of the lens having no distortion, since all points on the focal plane A1 are considered to have same disparity, the disparity v1 may be obtained by using the distance d1 obtained above (formula 3). Note that, due to distortion of the lens or the like, another value is used or correction is required for the distance d1 in some cases.

As shown in FIG. 6(b), from the right camera 12a, the origin P which is positioned on the focal plane A1 of the left camera 12b is seen in a direction at an angle 8x from a center thereof. When an interval between the right and left cameras is set as g, this θx is obtained with a following formula.

θx=arctan(g/d1) (formula 4)

At this time, the origin P is seen at the coordinate of the origin (0, 0) in the first image on the left side as shown in FIG. 7(a). Moreover, it is seen at a point of (−v1, 0) in the second image on the right side when a pixel number of disparity is set as v1 as shown in FIG. 7(b). As shown in FIG. 6(b), when a half of a horizontal view angle of the camera 12a is set as θ1, v1 is obtained with a following formula.

v1=w×tan θx/tan θ1 (formula 5)

Since v1 which is the pixel number of disparity is the same at the point P and the point (X, Y), it is to be seen at a position of (Xr, Y) in the right image. Here, it is set that:

Xr=X−v1 (formula 6).

Next, whether an object appearing at a coordinate of a detection region (X, Y) of the first image on the left side is at the same height with the road surface is determined. At this time, it may be confirmed whether an object same as the object appearing at the coordinate of (X, Y) of the first image on the left side appears at a position of a comparison region (Xr, Y) of the second image on the right side.

Though methods for confirming whether to be the same object includes various methods, for example, comparison may be made by extracting luminance for some pixels surrounding target points of the right and left images. When both are matched within a range of error factors such as noise of the cameras 12a and 12b, that point is able to be determined as being at the same height with the road surface. If both are not matched and are determined to be shifted to either leftward or rightward, it is possible to determine as being at a higher position or a lower position than the road surface according to disparity thereof.

For example, in a case where it is determined that an object which is at a position of (X, Y) of the first image on the left side is at a coordinate of (Xr−v2, Y) in the second image on the right side, when an actual distance to the object is set as d2, it is set that with (formula 4) and (formula 5):

v1=(w×g)/(d1×tan θ1)

v1+v2=(w×g)/(d2×tan θ1).

When v1 is eliminated, it is set that:

d2=(d×w×g)/(w×g+v2×tan θ1) (formula 7).

Here, as shown in FIGS. 8(a) and (b), a height hs of the object which is on the road surface meets:

hs=hc×(d1−d2)/d1 (formula 8),

which shows the height hs of a step on the road surface. That is, when the disparity v2 of the object is positive (larger than the disparity v1 of the road surface), as shown in FIG. 8(a), the distance d2 to the object becomes smaller than the distance d1 to the road surface and hs comes to have a positive value, so that it is possible to determine as being higher than the road surface. To the contrary, when v2 is negative (smaller than the disparity v1 of the road surface), as shown in FIG. 8(b), the distance d2 to the object becomes larger than the distance d1 to the road surface and hs comes to have a negative value, so that it is possible to determine as being lower than the road surface. In this manner, a difference in height from the road surface at the coordinate point (X, Y) in the first image is found.

The aforementioned procedure is repeated also at other coordinate points with an appropriate interval, and when detection of a height from the road surface is completed in a required range in the image, it is finished.

Note that, a method for calculating a distance to and a height of an obstacle from disparity of the stereo camera is not necessarily limited thereto and other well-known methods are usable.

Next, when detecting an obstacle by the obstacle detection sensor unit 10, the notification unit 20 shown in FIGS. 2 (a) and (b) notifies a driver of being risky for the driver with sound, voice or light emission for display.

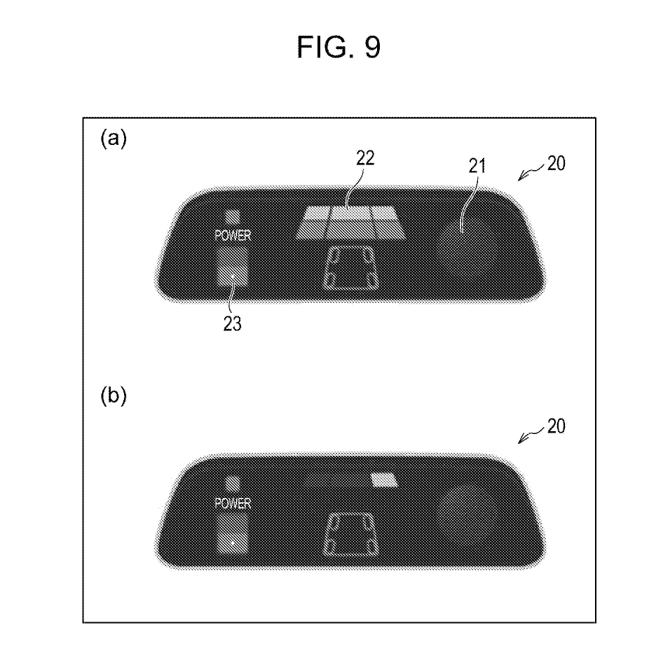

As the notification unit 20, for example, one shown in FIGS. 9(a) and (b) is usable. That is, the notification unit 20 is configured by a speaker unit 21 for notifying the driver with sound or voice, an LED display unit 22 for notifying the driver with light display, and a switch 23 for turning on/off operation of the notification unit 20. Note that, the notification unit 20 is provided with both of the speaker unit 21 and the LED display unit 22 in the present embodiment, but, without being necessarily limited thereto, may be provided with either one of them.

Meanwhile, detection of an obstacle by the stereo camera method is generally used because of having a simple configuration and being capable of measurement with relatively high precision. However, because of using camera images, an image of a target obstacle becomes difficult to be captured correctly depending on an illumination condition like a dark place or backlight or a weather condition including rainy weather or fog, so that erroneous judgment is caused in some cases. For example, it is a case where it is judged that there is no obstacle even though there is one or vice versa.

Moreover, when an obstacle on a road surface is detected, it is necessary to capture an image including the road surface, but when the road surface is in a mirror state or when being wet, a surrounding sight or illumination is reflected to be erroneously judged as an obstacle in some cases.

Thus, the obstacle detection device 4A of the present embodiment has the reliability calculation 14 and the determination unit 15 in order to judge that a situation is such that erroneous judgment is likely to be caused with the stereo camera method using the cameras 12a and 12b, that is, a situation is such that reliability is low as shown in FIG. 1. Then, it is set that when the reliability is low, attention of the driver is drawn by the notification unit 20.

In the aforementioned obstacle detection device 4A, the reliability calculation unit 14 calculates reliability based on signals of the cameras 12a and 12b. As the signals, luminance, a correlation degree, contrast, an exposure time or a combination thereof is preferably used. Description will be given below for calculation of reliability of each of them.

### [Luminance]

Reliability is calculated from luminance values of images captured by the cameras 12a and 12b. For example, when outputting luminance at a grayscale of 255, a pixel number with a luminance threshold of 230 or more is counted, and when the counted number is a fixed number or more, it is judged that the reliability is low. Thereby, it is possible to prevent that erroneous judgment is easily caused, for example, when there is much reflective light on a floor surface or a glossy surface like metal as well as to draw attention of a user to that obstacle detection is not performed successfully.

Moreover, it is more preferable to reduce erroneous judgment by ignoring pixels with the luminance threshold or more and detecting an obstacle with the stereo camera method. The luminance threshold and the counted number are able to be set arbitrarily. In addition, in a case where comparison of images of the cameras 12a and 12b is performed for each fixed block region in addition to count with the pixel number, when the pixel number with the luminance threshold or more is more than or equal to a fixed value in the block, the block may be ignored. For example, a method in which a range of around 64×32 pixels is set as one block and disparity at feature points of right and left images in the block is calculated is generally used in the stereo camera method. In this case, reliability of judgment in the block is discriminated from the pixel number with the luminance threshold or more included in the block, and when the number of blocks having low reliability is more than or equal to a fixed number, a user may be notified.

### [Correlation Degree]

In the stereo camera method, a shifted amount of disparity of feature points in fixed regions of images of the right and left cameras 12a and 12b is calculated and converted to a distance. At this time, a correlation degree which is a coincidence degree of the feature points is calculated. As the correlation degree is high, reliability of a result is considered to be high, and when the correlation degree is less than or equal to an arbitrary threshold, it is judged that the reliability of the result for the region is low. Further, when there is a fixed number or more of regions with low reliability, the reliability of the detection result itself is judged to be low and notified to the user.

For example, when a surrounding sight is reflected on a floor surface, it is erroneously judged that there is an obstacle even though there is none in some cases, but the reflected sight is generally not clear and an image becomes blurred. In this case, it becomes possible that the user is notified and warned to travel carefully when a situation where erroneous judgment is easily caused due to the reflection because the correlation degree has also decreased comes.

### [Contrast]

When disparity of the right and left images is calculated in a unit of a block as described above with the stereo camera method, a contrast difference (distribution) in the block may be calculated, a block whose contrast is lower than a fixed value may be judged as having low reliability, and the user may be notified when the number of blocks having low reliability is more than or equal to a fixed number. Moreover, erroneous detection of an obstacle may be reduced by ignoring a block having low reliability at the time of obstacle judgment.

By calculating reliability with contrast, it is possible to draw attention of the user by notifying that a situation is such that erroneous judgment is made easily in the case of a dark place like night-time or when an image is too bright due to backlight or the like.

### [Exposure Time]

Image capturing at the cameras 12a and 12b may be performed with automatic exposure to calculate reliability from an exposure time. When the exposure time is more than or equal to a fixed time or less than or equal to a fixed time, it is possible to determine that an image-capturing environment is too dark or too bright, and judge that detection precision for an obstacle has decreased.

Thereby, it is possible to draw attention of the user by notifying that a situation is such that an obstacle is erroneously judged easily in a situation of a dark place, backlight or the like.

By using signals of the cameras themselves, it is possible to discriminate brightness of an image-capturing environment without using an illuminance sensor or the like separately, and a configuration at low cost becomes possible.

In this manner, an obstacle is detected by the stereo camera in the obstacle detection device 4A of the present embodiment. In addition, signals of the stereo camera are used for judgment of reliability. Moreover, the reliability is calculated from signals other than disparity information of the stereo camera. Examples thereof include luminance, a correlation degree, contrast and an exposure time.

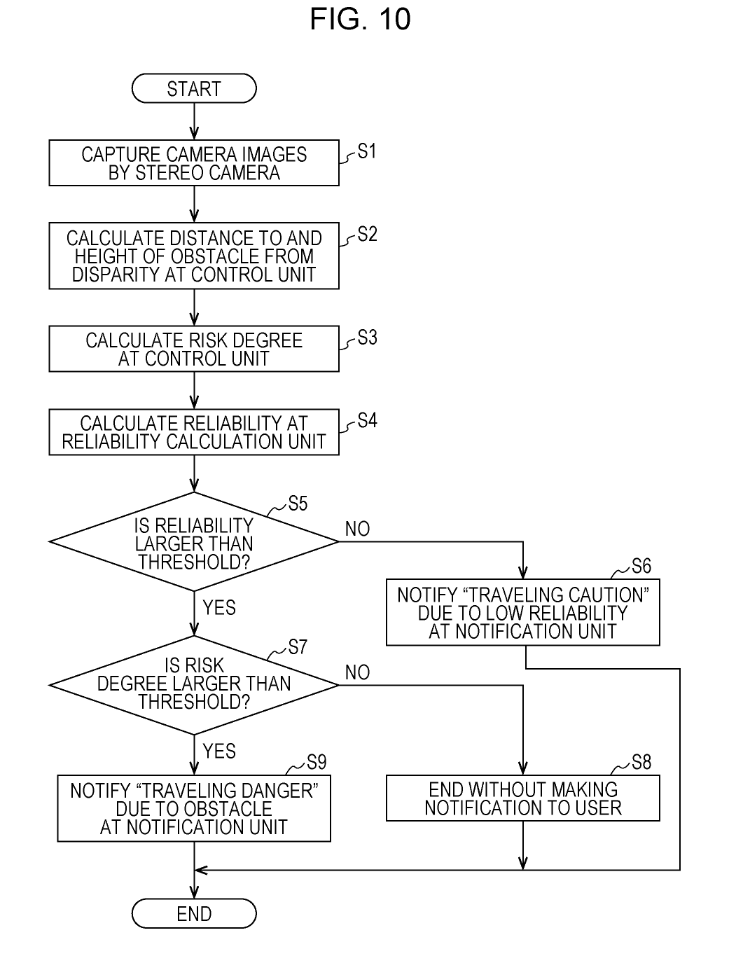

Description will be given for a judgment flow of reliability in the obstacle detection device 4A with the aforementioned configuration based on FIG. 10. FIG. 10 is a flowchart showing the judgment flow in the obstacle detection device 4A.

As shown in FIG. 10, camera images are captured by the right-side camera 12a and the left-side camera 12b serving as the stereo camera (S1). Subsequently, at the control unit 13, a height of and a distance to a target object are calculated from disparity of the right-side camera 12a and the left-side camera 12b (S2), and a risk degree is calculated (S3). The risk degree is determined from the distance to, and a height and a size of the target object. For example, in the case of being at close range, it is determined that the risk degree is large, and in the case of being at long range, it is determined that the risk degree is small. Then, reliability is calculated at the reliability calculation unit 14 with the method described above (S4). Subsequently, it is determined whether or not the reliability is larger than a threshold (S5), and when the reliability is less than or equal to the threshold, “traveling caution” is notified (S6). Moreover, when the reliability is larger than the threshold, it is further determined whether or not the risk degree is larger than a threshold (S7). When the risk degree is larger than the threshold, a user is then notified of a detection result of an obstacle by the notification unit 20 (S9). On the other hand, when the risk degree is less than or equal to the threshold, that is, when no obstacle is detected, no notification is made (S8) or “safe” is notified to the user.

In this manner, the obstacle detection device 4A of the present embodiment has the cameras 12a and 12b as the obstacle detection sensor for detecting an obstacle, and notifies the user when the obstacle is detected by the cameras 12a and 12b.

Here, for example, when the reliability of the cameras 12a and 12b has decreased because of fog or the like, etc., measurement is not able to be performed successfully, resulting that erroneous judgment is caused in some cases. In this case, in a case where, even when the reliability of the cameras 12a and 12b has decreased, the user believes the judgment as it is, an accident may be led, for example, when it is judged that there is no step even though there is a step.

Thus, in the present embodiment, the reliability calculation unit 14 for calculating reliability of detection of an obstacle by the cameras 12a and 12b, the determination unit 15 as a first determination unit for comparing the reliability which is calculated with a threshold and determining that the reliability has decreased when the reliability is less than or equal to the threshold, and the notification unit 20 as a first attention drawing unit for drawing attention of the user when the determination unit 15 determines that the reliability has decreased are provided.

Thereby, by drawing attention of the user in a situation where the reliability of judgment is low and erroneous determination is easily caused, the user is able to use the obstacle detection device 4A more safely and at ease. In a case where a situation where measurement is not able to be performed successfully, for example, when the reliability of the cameras 12a and 12b has decreased due to fog or the like, etc., comes, attention of the user is drawn to that effect. Thereby, the user is to perform operation more carefully without taking a result of the obstacle detection device 4A on faith, thus making it possible to prevent an accident.

Accordingly, it is possible to provide the obstacle detection device 4A capable of being used more safely and at ease by reducing erroneous judgment.

Moreover, in the obstacle detection device 4A of the present embodiment, the obstacle detection sensor is composed of the cameras 12a and 12b as the stereo camera for detecting an obstacle from disparity of a plurality of cameras. Thereby, it is possible to make the obstacle detection device easily with an inexpensive system by using the stereo camera which is conventionally and generally used as the obstacle detection sensor.

Moreover, in the obstacle detection device 4A of the present embodiment, the reliability calculation unit 14 calculates reliability from images captured by the cameras 12a and 12b.

Thereby, it is possible that a separate sensor for measuring reliability is not required by using images captured by the stereo camera as a method for calculating the reliability, thus making it possible to detect the reliability at low cost.

Here, as the method for calculating reliability from images captured by the stereo camera, for example, a luminance value, contrast, a correlation degree, or an exposure time is usable. This makes it possible to judge the reliability easily, and to easily judge that the reliability has decreased when disparity judgment precision has reduced due to lacking of a light quantity at night-time, local light incidence at the time of backlight, or low contrast.

Moreover, when the aforementioned correlation degree is used, a correlation degree indicating a matching degree of feature points of images of right and left cameras of the stereo camera is used as the method for calculating reliability. This makes it possible to judge the reliability, and, for example, by utilizing that the correlation degree decreases at the time of rainy weather or when blur of an image is generated due to reflecting on a road surface or the like, the decrease in the reliability is able to be detected to draw attention of the user.

Moreover, in the obstacle detection device 4A of the present embodiment, the reliability calculation unit 14 is able to calculate reliability based on luminance of images captured by the cameras 12a and 12b.

This makes it possible to judge the reliability easily by using a luminance value and to easily judge that the reliability has decreased when disparity judgment precision has reduced due to lacking of a light quantity at night-time, or local light incidence at the time of backlight. Moreover, both of a luminance value and a correlation degree are usable together. Thereby, it is possible to draw attention of the user to that the reliability has decreased in the case of weather like rainy weather or fog, an illumination condition like a dark place or backlight, or generation of reflecting of a floor surface or reflection of a surrounding sight. In this case, the user is able to perform operation more at ease by paying attention.

Moreover, in the obstacle detection device 4A of the present embodiment, the notification unit 20 as the first attention drawing unit is able to draw attention of the user to that reliability has decreased with at least one of sound, voice and display. This makes it possible to surely notify the user that the reliability has decreased aurally and visually.

In addition, the electric-powered vehicle 1 of the present embodiment is provided with the obstacle detection device 4A of the present embodiment. With the aforementioned configuration, it is possible to provide the electric-powered vehicle 1 capable of driving safely and at ease.

Moreover, it is possible to set that the electric-powered vehicle 1 of the present embodiment is provided with a driving control unit for controlling driving operation, and the driving control unit controls the driving operation based on a detection result of the aforementioned obstacle detection device.

This makes it possible to perform driving more safely and to prevent control mistake by erroneous judgment by not performing driving control of the electric-powered vehicle 1 when reliability is low.

### Embodiment 2

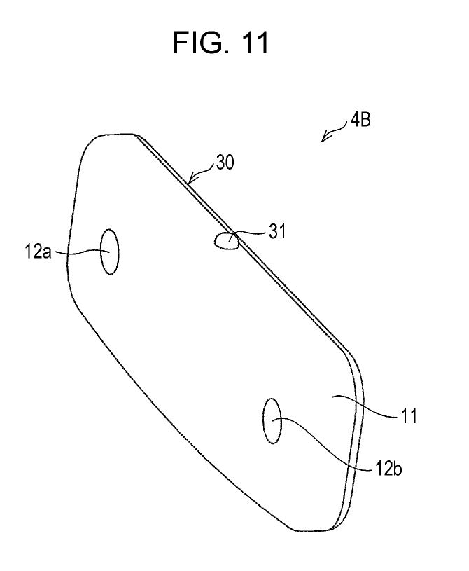

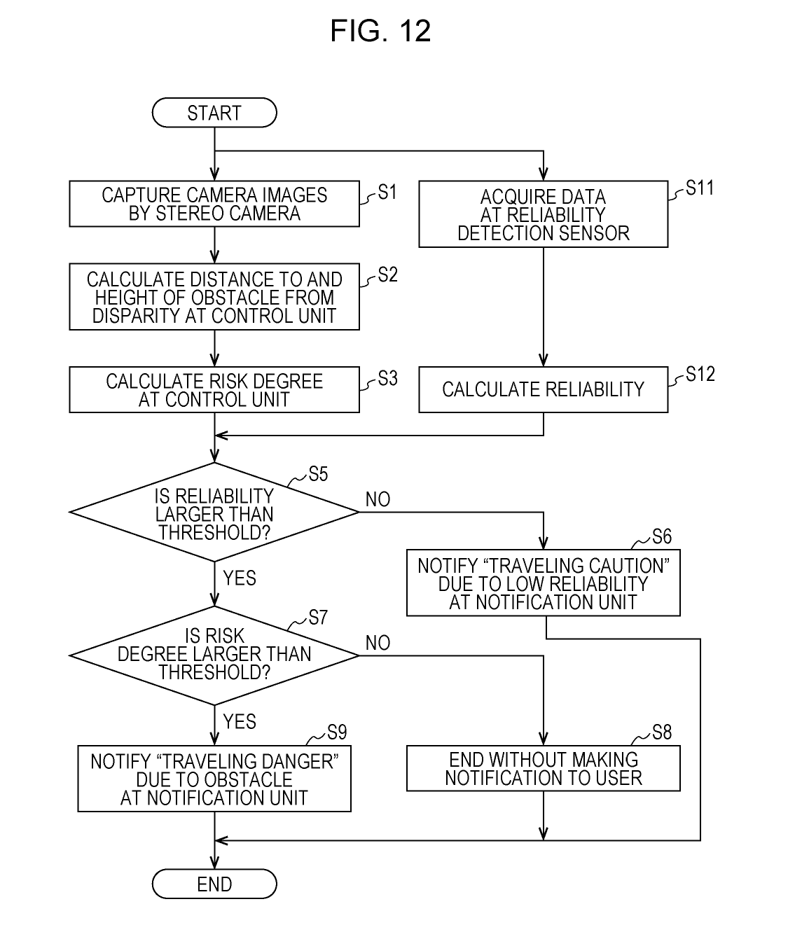

Description will be given as follows for another embodiment of the present invention based on FIG. 11 and FIG. 12. Not that, a configuration other than one that is described in the present embodiment is same as that of the aforementioned embodiment 1. Moreover, for convenience of description, same reference signs are assigned to members having same functions as those of members shown in the figures of the aforementioned embodiment 1 and description thereof will be omitted.

An obstacle detection sensor unit 30 in an obstacle detection device 4B of the present embodiment is different in terms of having a reliability detection sensor 31 as shown in FIG. 11 in addition to the configuration of the obstacle detection sensor unit 10 having the cameras 12a and 12b serving as the stereo camera of the aforementioned embodiment 1.

That is, the obstacle detection sensor unit 30 in the obstacle detection device 4B of the present embodiment detects an obstacle by the cameras 12a and 12b serving as the stereo camera. Moreover, it is set that, for example, an illuminance sensor or a temperature and humidity sensor is used other than the stereo camera for judgment of reliability.

Description will be given for a configuration of the obstacle detection sensor unit 30 of the present embodiment based on FIG. 11. FIG. 11 is a perspective view showing the configuration of the obstacle detection sensor unit 30 of the present embodiment.

The obstacle detection sensor unit 30 of the present embodiment includes the cameras 12a and 12b and a reliability detection sensor 31 in a sensor cover 11 as shown in FIG. 11.

As the aforementioned reliability detection sensor 31, for example, an illuminance sensor, a temperature and humidity sensor or the like is usable. When the illuminance sensor is used as the reliability detection sensor 31, illuminance surrounding the obstacle detection sensor unit 30 is detected, and when the illuminance is more than or equal to a fixed value or less than or equal to a fixed value, it is judged that the reliability has decreased. That is, when the illuminance is high, detection reliability at the cameras 12a and 12b serving as the stereo camera is likely to have decreased due to effects of backlight or reflective light. Moreover, when the illuminance is low, the detection reliability at the cameras 12a and 12b is likely to have decreased at night-time or in a dark place.

In addition, by using the temperature and humidity sensor as the reliability detection sensor 31, it is possible to predict a situation where rainy weather, fog, or condensation is easily caused, etc., and calculate the reliability from a result thereof.

In this manner, like the obstacle detection sensor unit 30 of the present embodiment, by using one other than the stereo camera as data for calculating reliability, it is possible to calculate reliability which is difficult to be calculated only with the stereo camera and to calculate the reliability more surely.

Description will be given for an operation flow of the obstacle detection device 4B provided with the obstacle detection sensor unit 30 with the aforementioned configuration based on FIG. 12. FIG. 12 is a flowchart showing obstacle detection operation of the obstacle detection device 4B of the present embodiment.

As shown in FIG. 12, in parallel with risk degree calculation at the stereo camera by S1 to S3, reliability is calculated by the reliability detection sensor 31 (S11, S12). Note that, since the subsequent flow (S5 to S9) is same as one described in the flowchart of FIG. 10, description thereof will be omitted.

In this manner, in the obstacle detection device 4B of the present embodiment, the reliability calculation unit 14 is provided with the reliability detection sensor 31 as the illuminance sensor for detecting surrounding brightness, and calculates reliability based on an output value of the reliability detection sensor 31.

Thereby, it becomes possible to judge reliability easily by detecting lightness and darkness of a measurement environment by the reliability detection sensor 31 as the illuminance sensor and determining that the reliability has decreased in the case of being too dark or in the case of being too bright. In addition, it becomes possible to perform judgment even in a situation where reliability is difficult to be judged with camera images.

Moreover, in the obstacle detection device 4B of the present embodiment, the notification unit 20 as the first attention drawing unit is able to draw attention of a user to that the reliability has decreased with at least one of sound, voice and display. This makes it possible to surely notify the user that the reliability has decreased aurally and visually.

In addition, the electric-powered vehicle 1 of the present embodiment is provided with the obstacle detection device 4B of the present embodiment. With the aforementioned configuration, it is possible to provide the electric-powered vehicle 1 capable of driving safely and at ease.

Moreover, it is possible to set that the electric-powered vehicle 1 in the present embodiment is provided with a driving control unit for controlling driving operation, and the driving control unit controls the driving operation based on a detection result of the aforementioned obstacle detection device. This makes it possible to perform driving more safely and to prevent control mistake by erroneous judgment by not performing driving control of the electric-powered vehicle when reliability is low.

### Embodiment 3

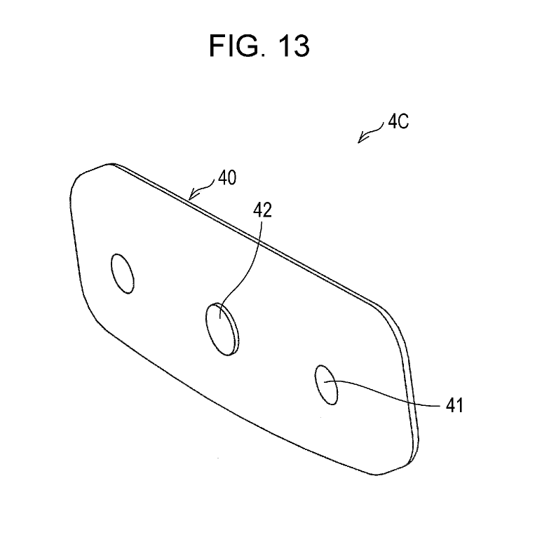

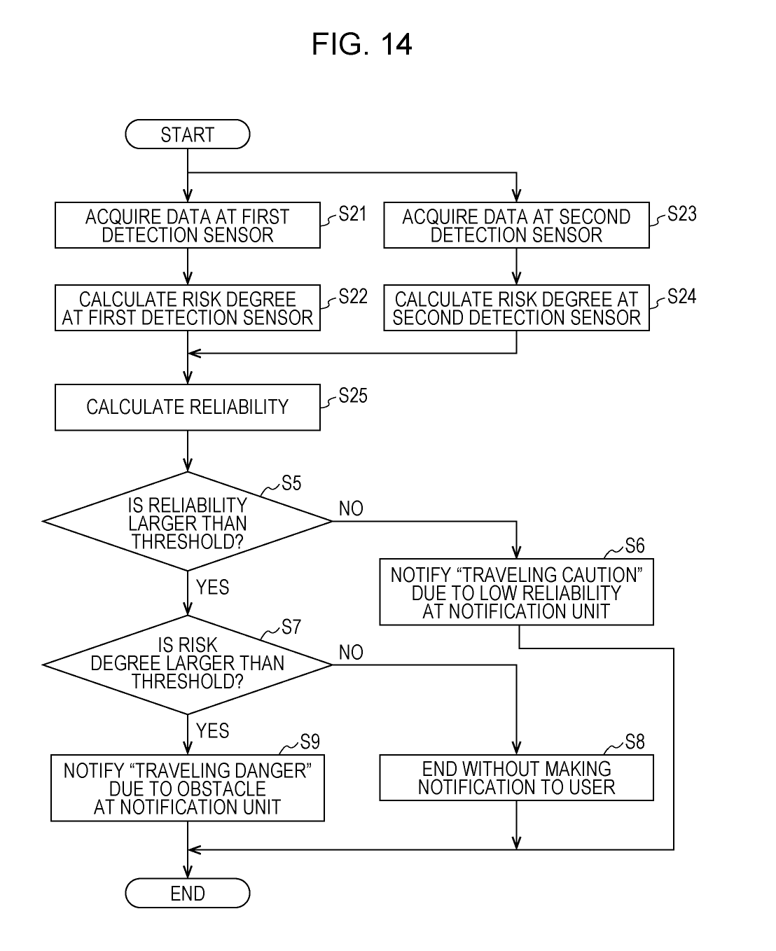

Description will be given as follows for still another embodiment of the present invention based on FIG. 13 and FIG. 14. Not that, a configuration other than one that is described in the present embodiment is same as those of the aforementioned embodiment 1 and embodiment 2. Moreover, for convenience of description, same reference signs are assigned to members having same functions as those of members shown in the figures of the aforementioned embodiment 1 and embodiment 2 and description thereof will be omitted.

An obstacle detection sensor unit 40 in an obstacle detection device 4C of the present embodiment is different in that a plurality of obstacle detection sensors are used together as shown in FIG. 13 in addition to the obstacle detection sensor unit 10 having the cameras 12a and 12b serving as the stereo camera of the aforementioned embodiment 1 and calculation is performed from a coincidence degree of the plurality of obstacle detection sensors as judgment of reliability. As the plurality of obstacle detection sensors, at least two of a first detection sensor 41 and a second detection sensor 42, for example, among a stereo camera, an ultrasonic sensor, radar, laser and the like, are used.

Description will be given for a configuration of the obstacle detection sensor unit 40 in the obstacle detection device 4C of the present embodiment based on FIG. 13. FIG. 13 is a perspective view showing the configuration of the obstacle detection sensor unit 40 of the present embodiment.

The obstacle detection sensor unit 40 of the present embodiment is provided with the first detection sensor 41 and the second detection sensor 42 as shown in FIG. 13. As the first detection sensor 41 and the second detection sensor 42, for example, so-called distance sensors among a stereo camera, an ultrasonic sensor, radar, laser and the like are usable.

For example, a stereo camera method is used as the first detection sensor 41 as well as the ultrasonic sensor is used as the second detection sensor 42. In this manner, sensors having different methods, that is, different detection principles are preferably combined for the first detection sensor 41 and the second detection sensor 42.

Description will be given for an operation flow of the obstacle detection device 4C provided with the obstacle detection sensor unit 40 of the present embodiment based on FIG. 14. FIG. 14 is a flowchart showing the operation flow of the obstacle detection device 4C.

As shown in FIG. 14, first, in parallel with risk degree calculation at the first detection sensor 41 (S21, S22), risk degree calculation by the second detection sensor 42 is performed (S23, S24), and reliability is then calculated (S25). As a method for calculating the reliability, when a detection result at the first detection sensor 41 and a detection result at the second detection sensor 42 are coincident, it is determined that the reliability is high, and when the detection results are not coincident, it is determined that the reliability is low. Note that, since the subsequent flow (S5 to S9) is same as ones described in the flowcharts of FIG. 10 and FIG. 12, description thereof will be omitted.

In this manner, in the obstacle detection device 4C in the present embodiment, the obstacle detection sensor is configured by the first detection sensor 41 and the second detection sensor 42 serving as the plurality of obstacle detection sensors having different detection methods from each other. In addition, a determination unit 15 as a second determination unit for determining that detection reliability has decreased when judgment results are different between the plurality of the first detection sensor 41 and the second detection sensor 42, and a notification unit 20 as a second attention drawing unit for drawing attention of a user when the determination unit 15 determines that the reliability has decreased are provided.

This makes it possible to determine that that the reliability is high in the case of same judgment when using a plurality of sensors having different characteristics, like the stereo camera and the ultrasonic sensor, and that the reliability is low in the case of being different. As a result thereof, it is possible to perform judgment of the reliability more surely. That is, an obstacle is detected at the first detection sensor 41 and the second detection sensor 42 serving as the plurality of obstacle detection sensors having different methods, and when results of both of them are not coincident, the reliability is judged to be low to be notified to a user. This makes it possible to notify the user that there is an obstacle only when detection has been performed more surely, and obtain the obstacle detection device 4C having very high reliability.

Moreover, in the obstacle detection device 4C of the present embodiment, the notification unit 20 as the second attention drawing unit is able to draw attention of the user to that the reliability has decreased with at least one of sound, voice and display. This makes it possible to surely notify the user that the reliability has decreased aurally and visually.

In addition, the electric-powered vehicle 1 in the present embodiment is provided with the obstacle detection device 4C of the present embodiment. With the aforementioned configuration, it is possible to provide the electric-powered vehicle 1 capable of driving safely and at ease.

Moreover, the electric-powered vehicle 1 in the present embodiment is provided with a driving control unit for controlling driving operation, and the driving control unit controls the driving operation based on a detection result of the obstacle detection device 4C. This makes it possible to perform driving more safely and to prevent control mistake by erroneous judgment by not performing driving control of the electric-powered vehicle 1 when the reliability is low.

### [Overview]

An obstacle detection device 4A in one aspect of the present invention is the obstacle detection device 4A having an obstacle detection sensor (cameras 12a, 12b) for detecting an obstacle and notifying a user when the obstacle is detected by the obstacle detection sensor (cameras 12a, 12b), the obstacle detection device including: a reliability calculation unit 14 for calculating reliability of detection of the obstacle by the obstacle detection sensor (cameras 12a, 12b), a first determination unit (determination unit 15) for comparing the reliability which is calculated with a threshold and determining that the reliability has decreased when the reliability is less than or equal to the threshold, and a first attention drawing unit (notification unit 20) for drawing attention of the user when the first determination unit (determination unit 15) determines that the reliability has decreased are provided.

With the aforementioned configuration, the reliability calculation unit for calculating reliability of detection of the obstacle by the obstacle detection sensor, the first determination unit for comparing the reliability which is calculated with the threshold and determining that the reliability has decreased when the reliability is less than or equal to the threshold, and the first attention drawing unit for drawing attention of the user when the first determination unit determines that the reliability has decreased are provided.

Thereby, by drawing attention of the user in a situation where reliability of judgment is low and erroneous determination is easily caused, the user is able to use the obstacle detection device more safely and at ease. In a case where a situation where measurement is not able to be performed successfully, for example, when reliability of the obstacle detection sensor has decreased due to fog or the like, etc., attention of the user is drawn to that effect, and thereby, the user is to perform operation more carefully without taking a result of the obstacle detection device on faith, thus making it possible to prevent an accident.

Accordingly, it is possible to provide the obstacle detection device capable of reducing erroneous judgment and being used more safely and at ease.

In the obstacle detection device 4A in an aspect 2 of the present invention, the obstacle detection sensor may comprise a stereo camera (cameras 12a, 12b) for detecting the obstacle from disparity of a plurality of cameras in the obstacle detection device 4A of the aspect 1.

Thereby, it is possible to make the obstacle detection device easily with an inexpensive system by using the stereo camera which is conventionally and generally used as the obstacle detection sensor.

In the obstacle detection device 4A in an aspect 3 of the present invention, it is preferable that the reliability calculation unit 14 calculates the reliability from images captured by the stereo camera (cameras 12a, 12b) in the obstacle detection device 4A of the aspect 2.

Thereby, it is possible that a separate sensor for measuring reliability is not required by using images captured by the stereo camera as a method for calculating reliability, thus making it possible to detect the reliability at low cost.

Here, as the method for calculating reliability from images captured by the stereo camera, for example, a luminance value, contrast, a correlation degree, or an exposure time is usable. This makes it possible to judge the reliability easily, and to easily judge that reliability has decreased when disparity judgment precision has reduced due to lacking of a light quantity at night-time, local light incidence at the time of backlight, or low contrast.

Moreover, when the aforementioned correlation degree is used, a correlation degree indicating a matching degree of feature points of images of right and left cameras of the stereo camera is used as the method for calculating reliability. This makes it possible to judge reliability, and, for example, by utilizing that the correlation degree decreases at the time of rainy weather or when blur of an image is generated due to reflecting on a road surface or the like, the decrease in the reliability is able to be detected to draw attention of the user.

In the obstacle detection device 4A in an aspect 4 of the present invention, the reliability calculation unit 14 may calculates the reliability based on luminance of the images captured by the stereo camera (cameras 12a, 12b) in the obstacle detection device 4A of the aspect 3.

This makes it possible to judge reliability easily by using a luminance value and to easily judge that the reliability has decreased when disparity judgment precision has reduced due to lacking of a light quantity at night-time, or local light incidence at the time of backlight. Moreover, by using both of a luminance value and a correlation degree together, it is possible to draw attention of the user to that the reliability has decreased in the case of weather like rainy weather or fog, an illumination condition like a dark place or backlight, or generation of reflection of a floor surface or reflection of a surrounding sight. In this case, the user is able to perform operation more at ease by paying attention.

In an obstacle detection device 4B in an aspect 5 of the present invention, the reliability calculation unit 14 may be provided with an illuminance sensor (reliability detection sensor 31) for detecting surrounding brightness, and may calculate the reliability based on an output value of the illuminance sensor (reliability detection sensor 31) in the obstacle detection device according to any one of the aspects 1 to 4.

Thereby, it becomes possible to judge reliability easily by detecting lightness and darkness of a measurement environment by the illuminance sensor and determining that the reliability has decreased in the case of being too dark or in the case of being too bright. In addition, it becomes possible to perform judgment even in a situation where reliability is difficult to be judged with camera images.

In the obstacle detection device 4A, 4B in an aspect 6 of the present invention, the first attention drawing unit (notification unit 20) may draw attention of the user to that the reliability has decreased with at least one of sound, voice and display in the obstacle detection device 4A, 4B according to any one of the aspects 1 to 5.

This makes it possible to surely notify the user that the reliability has decreased aurally and visually.

In an obstacle detection device 4C in an aspect 7 of the present invention, the obstacle detection sensor may be configured by a plurality of obstacle detection sensors (first detection sensor 41 and second detection sensor 42) having different detection methods from each other, and the obstacle detection device may comprise a second determination unit (determination unit 15) for determining that detection reliability has decreased when judgment results are different between the plurality of obstacle detection sensors (first detection sensor 41 and second detection sensor 42), and a second attention drawing unit (notification unit 20) for drawing attention of the user when the second determination unit (determination unit 15) determines that the reliability has decreased in the obstacle detection device according to any one of the aspects 1 to 6.

This makes it possible to determine that the reliability is high in the case of same judgment when using the plurality of sensors having different characteristics, like the stereo camera and the ultrasonic sensor, and that the reliability is low in the case of being different. As a result thereof, it is possible to perform judgment of reliability more surely.

An electric-powered vehicle 1 in one aspect of the present invention comprises the obstacle detection device 4A, 4B or 4C according to any one of aspects 1 to 7.

With the aforementioned configuration, it is possible to provide the electric-powered vehicle capable of driving safely and at ease.

In the electric-powered vehicle 1 in an aspect 9 of the present invention, a driving control unit for controlling driving operation may be provided, and the driving control unit may control the driving operation based on a detection result of the obstacle detection device in the electric-powered vehicle 1 according to the aspect 8.

This makes it possible to perform driving more safely and to prevent control mistake by erroneous judgment by not performing driving control of the electric-powered vehicle when reliability is low.

Note that, the present invention is not limited to each of the embodiments described above, various modifications are possible within the scope indicated in Claims, and an embodiment acquired by combining appropriately technical means each disclosed in a different embodiment is also included in the technical scope of the present invention.

### INDUSTRIAL APPLICABILITY

The present invention relates to an obstacle detection device which is used being mounted on an electric-powered vehicle such as an electric-powered wheelchair, and the electric-powered vehicle provided therewith, and is applicable to an electric-powered vehicle such as a three-wheel or four-wheel one-sheet electric-powered vehicle or mobility scooter which is made for elderly people, and an obstacle detection device mounted thereon.

### REFERENCE SIGNS LIST

1 electric-powered vehicle
2 sensor fixation unit
3 handle operation unit
4A obstacle detection device
4B obstacle detection device
4C obstacle detection device
10 obstacle detection sensor unit
11 sensor cover
12a camera (obstacle detection sensor, stereo camera)
12b camera (obstacle detection sensor, stereo camera)
13 control unit
14 reliability calculation unit
15 determination unit (first determination unit, second determination unit)
20 notification unit (first attention drawing unit, second attention drawing unit)
21 speaker unit
22 LED display unit
23 switch
30 obstacle detection sensor unit
31 reliability detection sensor (obstacle detection sensor)
40 obstacle detection sensor unit
41 first detection sensor (obstacle detection sensor)
42 second detection sensor (obstacle detection sensor)

1: An obstacle detection device having an obstacle detection sensor for detecting an obstacle and notifying a user when the obstacle is detected by the obstacle detection sensor, the obstacle detection device comprising:
a reliability calculation unit for calculating reliability of detection of the obstacle by the obstacle detection sensor;
a first determination unit for comparing the reliability which is calculated with a threshold and determining that the reliability has decreased when the reliability is less than or equal to the threshold; and
a first attention drawing unit for drawing attention of the user when the first determination unit determines that the reliability has decreased.

2: The obstacle detection device according to claim 1, wherein the obstacle detection sensor comprises a stereo camera for detecting the obstacle from disparity of a plurality of cameras.

3: The obstacle detection device according to claim 2, wherein the reliability calculation unit calculates the reliability from images captured by the stereo camera.

4: The obstacle detection device according to claim 3, wherein the reliability calculation unit calculates the reliability based on luminance of the images captured by the stereo camera.

5: The obstacle detection device according to claim 1, wherein the reliability calculation unit is provided with an illuminance sensor for detecting surrounding brightness, and calculates the reliability based on an output value of the illuminance sensor.

6: The obstacle detection device according to claim 1, wherein the first attention drawing unit draws attention of the user to that the reliability has decreased with at least one of sound, voice and display.

7: The obstacle detection device according to claim 1, wherein
the obstacle detection sensor is configured by a plurality of obstacle detection sensors having different detection methods from each other, and the obstacle detection device comprises:
a second determination unit for determining that detection reliability has decreased when judgment results are different between the plurality of obstacle detection sensors; and
a second attention drawing unit for drawing attention of the user when the second determination unit determines that the reliability has decreased.

8: An electric-powered vehicle provided with the obstacle detection device according to claim 1.

9: The electric-powered vehicle according to claim 8, wherein
a driving control unit for controlling driving operation is provided, and
the driving control unit controls the driving operation based on a detection result of the obstacle detection device.
